(19) United States
(12) Patent Application Publication
(10) Pub. No.: US 2020/0290409 A1
(43) Pub. Date: Sep. 17, 2020

(54) PNEUMATIC TIRE

(71) Applicant: BRIDGESTONE CORPORATION, Tokyo (JP)

(72) Inventor: Yuta HOSHINO, Tokyo (JP)

(73) Assignee: BRIDGESTONE CORPORATION, Tokyo (JP)

(21) Appl. No.: 16/889,990

(22) Filed: Jun. 2, 2020

Related U.S. Application Data
(63) Continuation of application No. PCT/JP2018/044796, filed on Dec. 5, 2018.

(30) Foreign Application Priority Data
Dec. 7, 2017 (JP) 2017-235435

(51) Int. Cl. B60C 19/12

(52) U.S. Cl. CPC B60C 19/122

(57) ABSTRACT

Provided is a pneumatic tire of the present disclosure comprising a puncture prevention member bonded to at least a part of an inner surface of a tire body, and the puncture prevention member satisfies relational expressions:

S≥100×M×T+4.5 and Y/(M×T)≥2, where M is a 100% modulus in MPa of a portion of the puncture prevention member in which the 100% modulus is lowest, T is a thickness in mm of the portion of the puncture prevention member, Y is an initial rigidity in N/mm during nail intruding, and S is a penetration strength in N of a portion of the puncture prevention member in which the penetration strength is highest.

### TECHNICAL FIELD

The present disclosure relates to a pneumatic tire.

### BACKGROUND

Heretofore, various measures against tire puncture have been made in a pneumatic tire.

For example, a so-called side portion reinforcement type of run flat tire is known in which a side rubber having a crescent cross section is disposed in a side portion (e.g., PTL1). According to such a tire, also after the tire is punctured, the side rubber takes over support of a load so that running can continue.

### CITATION LIST

### Patent Literature

PTL 1: Japanese Patent Laid-Open No. 2004-017668

### SUMMARY

### Technical Problem

In a run flat tire, however, a side rubber disposed as described above causes deterioration of ride comfort as well as increase in weight. Therefore, it is desirable to improve puncture resistance itself so that the tire is prevented from being punctured.

An object of the present disclosure is to provide a pneumatic tire in which puncture resistance is improved.

### Solution to Problem

A gist configuration of the present disclosure is as follows.

The present disclosure provides a pneumatic tire comprising a puncture prevention member bonded to at least a part of an inner surface of a tire body, wherein the puncture prevention member satisfies relational expressions:
S≥100×M×T+4.5 and Y/(M×T)≥2, where M is a 100% modulus in MPa of a portion of the puncture prevention member in which the 100% modulus is lowest, T is a thickness in mm of the portion of the puncture prevention member, Y is an initial rigidity in N/mm during nail intruding, and S is a penetration strength in N of a portion of the puncture prevention member in which the penetration strength is highest.

In the present description, “the 100% modulus” is a tensile stress during 100% elongation that is measured by preparing a No.3 dumbbell-shaped sample and performing a tensile test under conditions at room temperature of 23° C. and a speed of 500±25 mm/min in conformity with JIS K6251.

In the present description, for “the penetration strength”, an N100 nail prescribed by JIS standard and a cut sample of the above puncture prevention member having a diameter of 80 mm are prepared, the cut sample is attached to a pressure-resistant chamber, and a force is applied to the cut sample with the nail in a state where an internal pressure of 230 kPa is applied. Then, the penetration strength refers to a force to be applied to the nail when the cut sample penetrates the nail or when the cut sample ruptures. Note that if the nail is entirely intruded and the sample does not rupture, the strength refers to the force to be applied to the nail at this time.

Furthermore, “the initial rigidity during the nail intruding” is obtained by measuring a change in force to be applied to the nail in such a nail sticking test as described above when a nail intruding amount is from 3 to 10 mm in a stress-nail intruding amount curve where an abscissa axis indicates the nail intruding amount and an ordinate axis indicates the force to be applied to the nail.

Here, “the nail intruding amount during nail penetration” is the intruding amount of the nail when the nail penetrates the cut sample or when the cut sample ruptures. Note that even if the nail entirely intrudes, the sample does not rupture, and then L=80 mm.

### Advantageous Effect

According to the present disclosure, a pneumatic tire in which puncture resistance is improved can be provided.

### BRIEF DESCRIPTION OF THE DRAWINGS

In the accompanying drawings:

FIG. 1 is a tire width direction cross-sectional view of a pneumatic tire according to an embodiment of the present disclosure;

FIG. 2A is a schematic cross-sectional view illustrating a behavior immediately before a nail is stuck in a puncture prevention member;

FIG. 2B is a schematic cross-sectional view illustrating a behavior when the nail is stuck in the puncture prevention member;

FIG. 3A is a plan view illustrating a first protective layer of a laminated structure of the puncture prevention member;

FIG. 3B is a plan view illustrating a second protective layer of the laminated structure of the puncture prevention member;

FIG. 3C is a plan view illustrating a third protective layer of the laminated structure of the puncture prevention member;

FIG. 3D is a perspective plan view illustrating a configuration where the first to third protective layers of the puncture prevention member are laminated;

FIG. 4A is a plan view illustrating a first layer of a protective layer of a laminated structure of a puncture prevention member according to another embodiment;

FIG. 4B is a perspective plan view illustrating a configuration where first to fourth protective layers of the puncture prevention member according to the other embodiment are laminated;

FIG. 5A is a plan view illustrating a first layer of a protective layer of a laminated structure of a puncture prevention member according to still another embodiment;

FIG. 5B is a perspective plan view illustrating a configuration where first to third protective layers of the puncture prevention member according to the still another embodiment are laminated;

FIG. 6A is a plan view illustrating a first layer of a protective layer of a laminated structure of a puncture prevention member according to still another embodiment;

FIG. 6B is a perspective plan view illustrating a configuration where first to third protective layers of the puncture prevention member according to the still another embodiment are laminated;

FIG. 7A is a plan view illustrating a first layer of a protective layer of a laminated structure of a puncture prevention member according to the still another embodiment;

FIG. 7B is a plan view illustrating a second layer of the protective layer of the laminated structure of the puncture prevention member according to the still another embodiment;

FIG. 7C is a plan view illustrating a third layer of the protective layer of the laminated structure of the puncture prevention member according to still another embodiment;

FIG. 7D is a perspective plan view illustrating a configuration where first to third protective layers of the puncture prevention member according to the still another embodiment are laminated;

FIG. 8 is a tire width direction cross-sectional view of a pneumatic tire according to a further embodiment of the present disclosure; and

FIG. 9 is a tire width direction cross-sectional view of a pneumatic tire according to a still another embodiment of the present disclosure.

### DETAILED DESCRIPTION

Hereinafter, embodiments of the present disclosure will be illustratively described in detail with reference to the drawings.

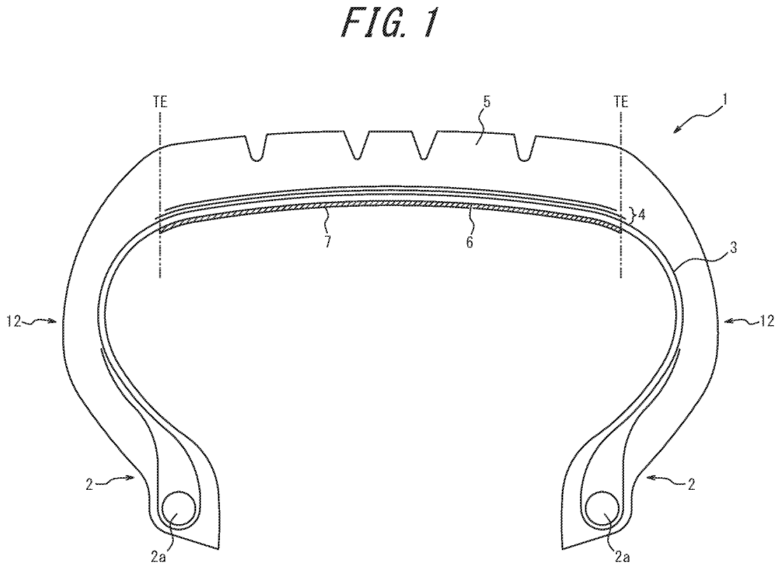

FIG. 1 is a tire width direction cross-sectional view of a pneumatic tire according to an embodiment of the present disclosure. FIG. 1 illustrates a tire width direction cross section of a pneumatic tire 1 in a state where the tire is mounted to an applicable rim, and charged with a prescribed internal pressure and no load. As illustrated in FIG. 1, the pneumatic tire 1 (hereinafter, also referred to simply as the tire) comprises a belt 4 including one or more (in an illustrated example, two) belt layers, and a tread 5 in order, on an outer side of a carcass 3 that toroidally straddles bead cores 2a embedded in a pair of bead portions 2 in the outside of a tire radial direction.

Note that there are not any special restrictions on an inner structure of the tire, excluding a puncture prevention member bonded to an inner surface of a tire body that will be described later. According to convention, the inner structure can be an arbitrary tire inner structure. For example, the tire does not have to include any bead cores, and there are not any special restrictions on a material and a number of carcass plies and on a number of layers of the belt layer.

Here, “the applicable rim” indicates an approved rim in an applicable size (a measuring rim in Standards Manual of ETRTO, and a design rim in Year Book of TRA) described or to be described in future in an industrial standard effective in a district where the tire is produced and used, for example, JATMA Year Book of JATMA (The Japan Automobile Tyre Manufacturers Association) in Japan, Standards Manual of ETRTO (The European Tyre and Rim Technical Organization) in Europe, Year Book of TRA (The Tire and Rim Association, Inc.) in U.S. or the like (that is, the above “rim” also includes a size that can be included in the above industrial standard in future, in addition to the existing size. Examples of “the size to be described in future” include sizes described as “future developments” in 2013 edition of Standards Manual of ETRTO). However, it is considered that a rim having a size that is not described in the above industrial standard is a rim having a width corresponding to a bead width of the tire. Additionally, “the prescribed internal pressure” indicates an air pressure (a maximum air pressure) corresponding to a tire maximum load capability in a tire of an applicable size in a standard of JATMA or the like. Note that “the prescribed internal pressure” having a size that is not described in the above industrial standard is an air pressure (the maximum air pressure) corresponding to the maximum load capability prescribed for each vehicle to which the tire is mounted. Furthermore, “a maximum load” described later indicates a load corresponding to the above tire maximum load capability of the standard of JATMA or the like in the tire of the applicable size, or the maximum load having a size that is not described in the above industrial standard is a load corresponding to the maximum load capability prescribed for each vehicle to which the tire is mounted.

Here, as illustrated in FIG. 1, in the tire of the present embodiment, a puncture prevention member 7 is bonded to at least a part of an inner surface 6 of the tire body. In the present embodiment, the puncture prevention member 7 is disposed only in the inner surface 6 (hereinafter, also referred to as a tread portion inner surface) of the tire body of a tire width direction region between tread edges TE of the tread 5 in the inner surface 6 of the tire body, and is not disposed in another region (a sidewall portion inner surface or a bead portion inner surface). Furthermore, in this example, the puncture prevention member 7 is bonded to a region of at least a part of the inner surface 6 of the tire body. Specifically, the member is bonded only to opposite end portions of the tread portion inner surface (e.g., each region having 3% of a peripheral length of the whole tread portion inner surface) in the tread portion inner surface, and is not bonded to another region of the tread portion inner surface. On the other hand, in the present disclosure, the whole surface of the puncture prevention member 7 is bonded to the inner surface 6 of the tire body, while at least a part of the puncture prevention member 7 may be configured to be away from the inner surface 6 of the tire body during the nail intruding, and in any of above cases, an effect of sufficiently dispersing an input of force by a nail 11 described later can be obtained. Note that in case where the puncture prevention member 7 is bonded to a region of at least a part of the inner surface 6 of the tire body, an input of force by the nail 11 can be uniformly dispersed. On the other hand, in case where at least a part of the puncture prevention member 7 is configured to be away from the inner surface 6 of the tire body during the nail intruding while the whole surface of the puncture prevention member 7 is bonded to the inner surface 6 of the tire body, a number of steps in manufacturing can be reduced.

Here, “the tread edge” refers to a tire width direction outermost edge of a contact patch when the tire is mounted to the applicable rim, and charged with the prescribed internal pressure and the maximum load.

Here, in the present embodiment, the puncture prevention member 7 satisfies relational expressions:
S≥100×M×T+4.5 and Y/(M×T)≥2, where M is a 100% modulus in MPa of a portion of the puncture prevention member in which the 100% modulus is lowest, T is a thickness in mm of the portion of the puncture prevention member 7, Y is an initial rigidity in N/mm during the nail intruding, and S is a penetration strength in N of a portion of the puncture prevention member 7 in which the penetration strength is highest.

Hereinafter, operations and effects of the pneumatic tire of the present embodiment will be described.

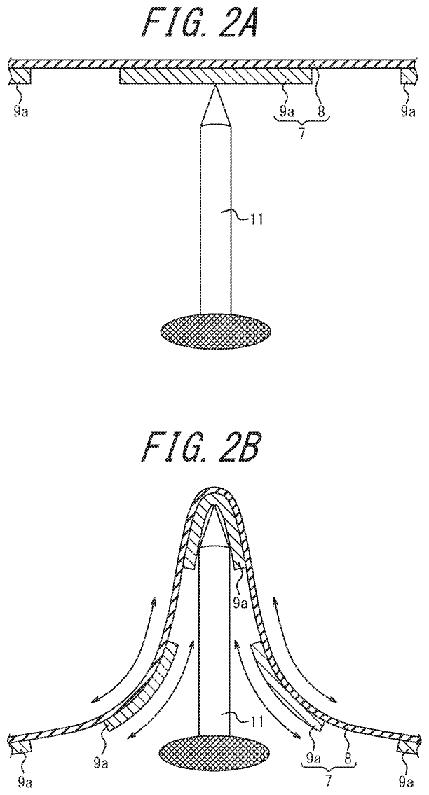

FIG. 2A is a schematic cross-sectional view illustrating a behavior immediately before the nail 11 is stuck in the puncture prevention member 7. FIG. 2B is a schematic cross-sectional view illustrating a behavior when the nail 11 is stuck in the puncture prevention member 7.

According to the tire of the present embodiments, the puncture prevention member 7 that satisfies the above relational expressions and is relatively stretchable against rupture strength is disposed in the tread portion inner surface. Consequently, as illustrated in FIG. 2A and FIG. 2B, the input of force by the nail 11 can be sufficiently dispersed, rupture of the puncture prevention member 7 due to the input of force of the nail 11 can be inhibited, and puncture resistance of the tire can be improved.

Thus, according to the tire of the present embodiment, the puncture resistance can be improved.

In the present disclosure, there are not any special restrictions on a structure and a material of the puncture prevention member 7 as long as the above relational expressions are satisfied. Hereinafter, the structure and material will be illustratively described.

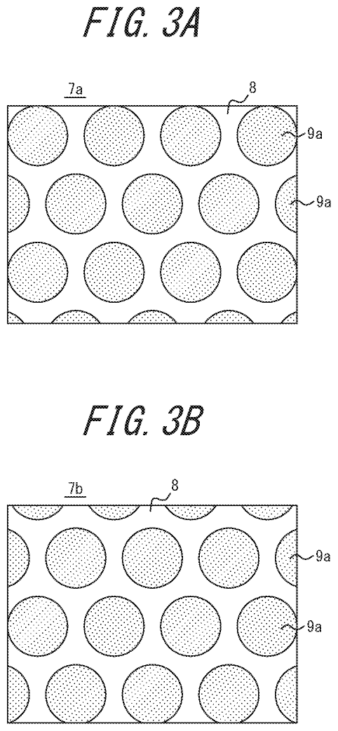

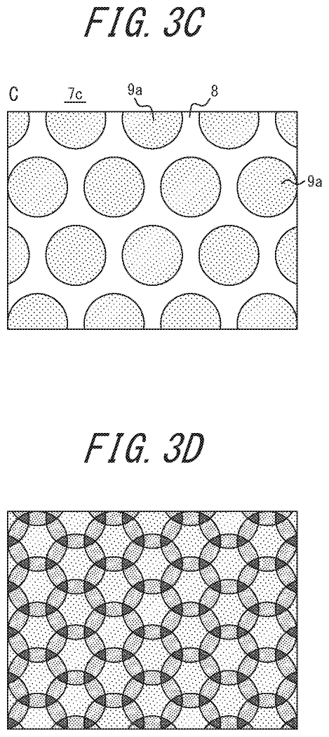

FIG. 3A is a plan view illustrating a first protective layer 7a of a laminated structure of the puncture prevention member 7. FIG. 3B is a plan view illustrating a second protective layer 7b of the laminated structure of the puncture prevention member 7. FIG. 3C is a plan view illustrating a third protective layer 7c of the laminated structure of the puncture prevention member 7. FIG. 3D is a perspective plan view illustrating a configuration where the first to third protective layers 7a to 7c of the puncture prevention member 7 are laminated. As illustrated in FIG. 3A to FIG. 3D, the puncture prevention member 7 in this example comprises a plurality of (in this example, three) protective layers 7a to 7c. On the other hand, in the present disclosure, the puncture prevention member 7 may be constituted of a single layer.

In the present embodiment, as illustrated in FIG. 3A to FIG. 3D, the puncture prevention member 7 includes one or more (in this example, three) protective layers 7a to 7c including an internal pressure holding layer 8, and a protective material 9a disposed on a tire outer surface side of the internal pressure holding layer 8 (in this example, a thin film rubber) in a region of at least a part of an extending region of the internal pressure holding layer 8.

Furthermore, as illustrated in FIG. 3A to FIG. 3C, the puncture prevention member 7 comprises the plurality of laminated protective layers 7a to 7c in each of which a plurality of protective materials 9a having a round shape in planar view are arranged by mutually shifting a phase between the layers so that at least one or more protective materials 9a are present when seen in a laminating direction of the plurality of (in this case, three) layers as illustrated in FIG. 3D.

In more detail, according to the present embodiment, in the first protective layer 7a illustrated in FIG. 3A, the protective materials 9a having the round shape in the planar view and arranged via a predetermined equal space in a column direction (an illustrated lateral direction) are arranged in plurality of rows (a row direction is an illustrated vertical direction). In an illustrated example, in one row, the shortest distance between the round protective materials 9a is smaller than a radius of the round protective material 9a.

Furthermore, in the illustrated example, the round protective materials 9a are arranged by aligning phases of rows adjacent to each other via one row (e.g., odd columns) so that the rows are completely superimposed on each other when projected in the row direction. On the other hand, adjacent rows (an odd row and an even row) are arranged by shifting a phase just by a half of the above predetermined space in the column direction.

Next, as illustrated in FIG. 3B, the round protective materials 9a are arranged also in the second layer 7b in the same manner as in the first layer 7a. Here, in a positional relation of the round protective materials 9a between the first layer 7a illustrated in FIG. 3A and the second layer 7b illustrated in FIG. 3B, the protective materials 9a in the second layer 7b are arranged to shift from the arrangement of the protective materials 9a in the first layer 7a by a half pitch in the row direction (a half of a pitch space in the row direction).

As illustrated in FIG. 3C, the round protective materials 9a are arranged also in the third protective layer 7c in the same manner as in the first protective layer 7a. Here, a positional relation of the round protective materials 9a between the first layer 7a illustrated in FIG. 3A and the third layer 7c illustrated in FIG. 3C, the protective materials 9a in the third layer 7c are arranged to shift from the arrangement of the protective materials 9a in the first layer 7a by a half pitch (a half of a pitch space in the column direction) in the column direction.

As illustrated in FIG. 3D, in the puncture prevention member 7 in a state where the first to third layers 7a to 7c are laminated, at least one or more protective materials 9a are present when seen in the laminating direction of the plurality of layers (in this example, three layers). More specifically, as illustrated in FIG. 3D, the puncture prevention member 7 includes a portion comprising one layer of the protective layer (an almost hexagonal portion in perspective planar view that is illustrated with sparsest dots), a portion comprising two layers (an almost rectangular portion in perspective planar view that is illustrated with mediumly dense dots) and a portion comprising three layers (an almost triangular portion in perspective planar view that is illustrated with densest dots).

In this way, a plurality of protective materials 9a are arranged by mutually shifting the phase between the layers so that at least one or more protective materials 9a are present when seen in the laminating direction of the plurality of layers.

As illustrated in FIG. 3D, in a laminated state, one protective material 9a overlaps with a region of a part of each of six surrounding protective materials 9a. A central position of six surrounding protective materials 9 forms a hexagonal shape in this perspective plan view.

Note that there are not any special restrictions on a laminating order of the first to third protective layers 7a to 7c, and the order may be any of all possible laminating orders.

In the configuration illustrated in FIG. 3A to FIG. 3D, the internal pressure holding layer 8 can be arbitrarily selected from a natural rubber, a synthetic rubber such as butadiene rubber, styrene butadiene rubber, isoprene rubber, butyl rubber, or nitrile rubber, a thermoplastic elastomer such as styrene-based elastomer, olefin-based elastomer, ester-based elastomer, urethane-based elastomer or polyamide-based elastomer, or any blend of these materials, having a thickness of 0.05 to 1 mm. Furthermore, in the present disclosure, the protective material 9a may be a non-woven fabric, a film, a rubber, a steel plate or any combination of these materials, having a thickness of 0.05 to 3 mm.

In this way, as an example, by use of the configuration illustrated in FIG. 3A to FIG. 3D and the material exemplified above, the puncture prevention member 7 that satisfies the above described relational expressions can be configured.

Here, in the present disclosure, it is preferable that the protective layers 7a to 7c include the internal pressure holding layer 8, and at least either a fabric or a knitted material is further disposed on a tire outer surface side of the internal pressure holding layer 8 and a tire inner side of the protective material 9a. An extending region of the fabric or the knitted material may be, for example, the same as the extending region of the internal pressure holding layer 8. In the present embodiment, there may be used the fabric in which elastic polyurethane or polytrimethylene terephthalate is used or the knitted material in which an organic fiber for use in a general industrial product, such as polyester or nylon, is used. However, these materials are merely illustrations, and a raw material is not especially limited. Note that for the fabric and the knitted material, a thread or a cord having a fineness of 10 to 1100 dtex may be woven or knitted.

As an example, such a configuration and material can constitute the puncture prevention member 7 that satisfies the above described relational expressions.

Furthermore, at least either the fabric or the knitted material stretches against the input of force by the nail 11, so that the input of force can be further dispersed. Additionally, either the fabric or the knitted material is disposed, so that it is possible to enhance an effect of preventing the internal pressure holding layer 8 from flowing out of a punctured location by the air pressure in the tire after the nail 11 is pulled outside.

In the present disclosure, it is preferable that the puncture prevention member 7 includes the plurality of laminated protective layers 7a to 7c, the plurality of protective materials 9a having the round shape in planar view are arranged in each layer, and the plurality of protective materials 9a are arranged by mutually shifting the phase between the layers so that at least one or more protective materials 9a are present when seen in the laminating direction of the plurality of layers.

This is because it is possible to obtain an effect of protecting, by the protective material 9a , the puncture prevention member 7 from rupture by a tip of the nail 11, even in any location.

In the present disclosure, it is preferable that a penetration strength S is 45 N or more. This is because when the penetration strength S is 45 N or more, sufficient strength can be acquired against external input of force to prevent penetration rupture. Furthermore, in the present disclosure, it is preferable that the penetration strength S is 60 N or more. For similar reasons, the puncture resistance can be acquired against larger input of force.

Furthermore, in the present disclosure, it is preferable that a nail intruding amount L during the nail penetration is 20 mm or more. This is because the input of force by the nail can be sufficiently dispersed, and the puncture resistance can be improved. Additionally, in the present disclosure, the nail intruding amount L during the nail penetration is preferably 50 mm or more. For similar reasons, the puncture resistance can be improved against the larger input of force.

Here, it is preferable that the above thickness T is 0.05 mm or more.

In the present disclosure, it is preferable that the 100% modulus M of the portion of the puncture prevention member 7 in which the 100% modulus is lowest is from 0.1 to 10 MPa.

The above 100% modulus M is set to 0.1 MPa or more, so that manufacturing operability as a member can be secured. On the other hand, the above 100% modulus M is set to 10 MPa or less, so that puncture resistance can be further improved.

For similar reasons, the 100% modulus M of the portion of the puncture prevention member 7 in which the 100% modulus is lowest is preferably from 0.2 to 7 MPa, and further preferably from 0.2 to 3 MPa.

Furthermore, in the present disclosure, it is preferable that a gas permeability coefficient of a portion of the puncture prevention member 7 in which the gas permeability coefficient is highest at 60° C. is 6.0×10⁻¹⁰ cc·cm/cm²·sec·cmHg or less.

An effect of holding an internal pressure of the tire can be enhanced.

In the example illustrated in FIG. 3A to FIG. 3D, the protective layer includes three layers, but in the present disclosure, the protective layer may include two layers, and four or more layers. Also, in these cases, it is preferable that the protective layer is configured so that at least one or more protective materials 9a are present when seen in the laminating direction of the plurality of layers. Furthermore, for reasons similar to the above described reasons, in these cases, it is more preferable that the puncture prevention member 7 includes the plurality of laminated protective layers, the plurality of protective materials 9a having the round shape in planar view are arranged in each layer, and the plurality of protective materials 9a are arranged by mutually shifting the phase between the layers so that at least one or more protective materials 9a are present when seen in the laminating direction of the plurality of layers.

Furthermore, in the example illustrated in FIG. 3A to FIG. 3D, the protective material 9a has the round shape in planar view, but in the present disclosure, the protective material 9a may have various shapes such as an elliptic shape and a polygonal shape, e.g., a triangular, quadrangular, hexagonal or octagonal shape in planar view, and two or more of these shapes may be combined.

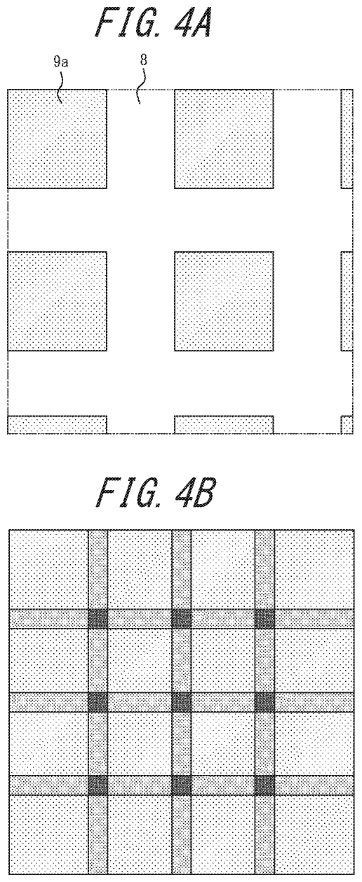

FIG. 4A is a plan view illustrating a first layer of a protective layer of a laminated structure of a puncture prevention member according to another embodiment. FIG. 4B is a perspective plan view illustrating a configuration where first to fourth protective layers of the puncture prevention member according to the other embodiment are laminated.

In this example, a puncture prevention member 7 includes one or more (in this example, four) protective layers including an internal pressure holding layer 8, and a protective material 9a disposed on a tire outer surface side of the internal pressure holding layer 8 (in this example, a thin film rubber) in a region of at least a part of an extending region of the internal pressure holding layer 8.

Furthermore, as the first layer is representatively illustrated in FIG. 4A, the puncture prevention member 7 comprises a plurality of protective materials 9a having a quadrangular shape in planar view and arranged in each layer of the protective layer (in an illustrated range, two rows and two columns), and as illustrated in FIG. 4B, a plurality of protective materials 9a are arranged by mutually shifting a phase between the layers so that at least one or more protective materials 9a are present when seen in a laminating direction of a plurality of (in this example, four) layers.

Although illustration is omitted, second to fourth protective layers are used in addition to the protective layer illustrated in FIG. 4A. As can be understood from FIG. 4B, in the second protective layer, the protective materials 9a having the quadrangular shape in planar view are arranged by shifting a phase from the first protective layer only in a row direction, and in the third protective layer, the protective materials 9a having the quadrangular shape in planar view are arranged by shifting the phase from the first protective layer only in a column direction. Furthermore, in the fourth protective layer, the protective materials 9a having the quadrangular shape in planar view are arranged by shifting the phase from the second protective layer only in the column direction.

Consequently, as illustrated in FIG. 4B, in the puncture prevention member 7 in a state where first to fourth layers are laminated, at least one or more protective materials 9a are present when seen in the laminating direction of the plurality of layers (in this example, four layers). More specifically, as illustrated in FIG. 4B, the puncture prevention member 7 includes a portion comprising one layer of the protective layer (a quadrangular portion in perspective planar view that is illustrated with sparsest dots), a portion comprising two layers (a rectangular portion in perspective planar view that is illustrated with mediumly dense dots) and a portion comprising four layers (a quadrangular portion in perspective planar view that is illustrated with densest dots).

In this way, the plurality of protective materials 9a are arranged by mutually shifting the phase between the layers so that at least one or more protective materials 9a are present when seen in the laminating direction of the plurality of layers.

Note that there are not any special restrictions on a laminating order of the first to four protective layers, and the order may be any of all possible laminating orders.

In the configuration illustrated in FIG. 4A, FIG. 4B, the internal pressure holding layer 8 can be arbitrarily selected from a natural rubber, a synthetic rubber such as butadiene rubber, styrene butadiene rubber, isoprene rubber, butyl rubber, or nitrile rubber, a thermoplastic elastomer such as styrene-based elastomer, olefin-based elastomer, ester-based elastomer, urethane-based elastomer or polyamide-based elastomer, or any blend of these materials, having a thickness of 0.05 to 1 mm. Furthermore, in the present disclosure, the protective material 9a may be a non-woven fabric, a film, a rubber, a steel plate or any combination of these materials, having a thickness of 0.05 to 3 mm.

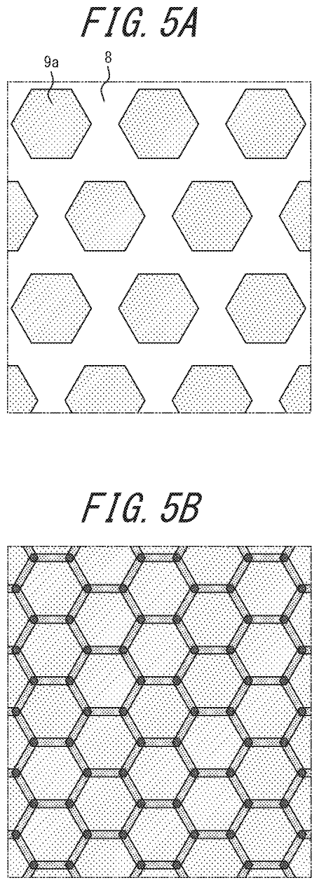

FIG. 5A is a plan view illustrating a first layer of a protective layer of a laminated structure of a puncture prevention member according to a further embodiment. FIG. 5B is a perspective plan view illustrating a configuration where first to third protective layers of the puncture prevention member according to the further embodiment are laminated.

In this example, a puncture prevention member 7 includes one or more (in this example, three) protective layers including an internal pressure holding layer 8, and a protective material 9a disposed on a tire outer surface side of the internal pressure holding layer 8 (in this example, a thin film rubber) in a region of at least a part of an extending region of the internal pressure holding layer 8.

Furthermore, as a first layer is representatively illustrated in FIG. 5A, the puncture prevention member 7 comprises a plurality of protective materials 9a having a hexagonal shape in planar view and arranged in each layer of the protective layer, and as illustrated in FIG. 5B, a plurality of protective materials 9a are arranged by mutually shifting a phase between the layers so that at least one or more protective materials 9a are present when seen in a laminating direction of a plurality of layers (in this example, three layers).

Although illustration is omitted, second and third protective layers are used in addition to the protective layer illustrated in FIG. 5A. As can be understood from FIG. 5B, in the second protective layer, the protective materials 9a having the hexagonal shape in planar view are arranged by shifting a phase from the first protective layer only in a row direction (by ⅓ of a pitch in the row direction), and in the third protective layer, the protective materials 9a having the hexagonal shape in planar view are arranged by shifting the phase from the first protective layer only in the row direction (by ⅔ of the pitch in the row direction).

Consequently, as illustrated in FIG. 5B, in the puncture prevention member 7 in a state where first to third layers are laminated, at least one or more protective materials 9a are present when seen in the laminating direction of the plurality of layers (in this example, three layers). More specifically, as illustrated in FIG. 5B, the puncture prevention member 7 includes a portion comprising one layer of the protective layer (an almost hexagonal portion in perspective planar view that is illustrated with sparsest dots), a portion comprising two layers (an almost rectangular portion in perspective planar view that is illustrated with mediumly dense dots) and a portion comprising three layers (a hexagonal portion in perspective planar view that is illustrated with densest dots).

In this way, the plurality of protective materials 9a are arranged by mutually shifting the phase between the layers so that at least one or more protective materials 9a are present when seen in the laminating direction of the plurality of layers.

Note that there are not any special restrictions on a laminating order of the first to third protective layers, and the order may be any of all possible laminating orders.

In the configuration illustrated in FIG. 5A, FIG. 5B, the internal pressure holding layer 8 can be arbitrarily selected from a natural rubber, a synthetic rubber such as butadiene rubber, styrene butadiene rubber, isoprene rubber, butyl rubber, or nitrile rubber, a thermoplastic elastomer such as styrene-based elastomer, olefin-based elastomer, ester-based elastomer, urethane-based elastomer or polyamide-based elastomer, or any blend of these materials, having a thickness of 0.05 to 1 mm. Furthermore, in the present disclosure, the protective material 9a may be a non-woven fabric, a film, a rubber, a steel plate or any combination of these materials, having a thickness of 0.05 to 3 mm.

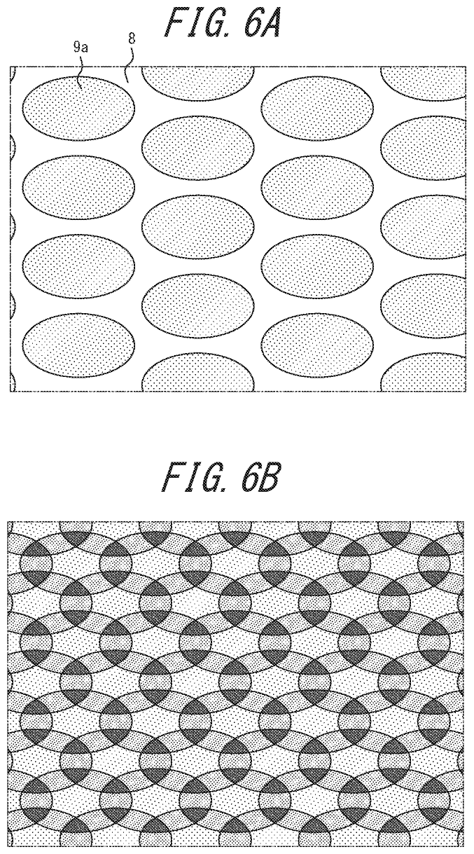

FIG. 6A is a plan view illustrating a first layer of a protective layer of a laminated structure of a puncture prevention member according to a further embodiment. FIG. 6B is a perspective plan view illustrating a configuration where first to third protective layers of the puncture prevention member according to the further embodiment are laminated.

In this example, a puncture prevention member 7 includes one or more (in this example, three) protective layers including an internal pressure holding layer 8, and a protective material 9a disposed on a tire outer surface side of the internal pressure holding layer 8 (in this example, a thin film rubber) in a region of at least a part of an extending region of the internal pressure holding layer 8.

Furthermore, as a first layer is representatively illustrated in FIG. 6A, the puncture prevention member 7 comprises a plurality of protective materials 9a having an elliptic shape in planar view and arranged in each layer of the protective layer, and as illustrated in FIG. 6B, a plurality of protective materials 9a are arranged by mutually shifting a phase between the layers so that at least one or more protective materials 9a are present when seen in a laminating direction of a plurality of layers (in this example, three layers).

Although illustration is omitted, second and third protective layers are used in addition to the protective layer illustrated in FIG. 6A. As can be understood from FIG. 6B, in the second protective layer, the protective materials 9a having the elliptic shape in planar view are arranged by shifting a phase from the first protective layer only in a column direction (by ⅓ of a pitch in the column direction), and in the third protective layer, the protective materials 9a having the elliptic shape in planar view are arranged by shifting the phase from the first protective layer only in the column direction (by ⅔ of the pitch in the column direction).

Consequently, as illustrated in FIG. 6B, in the puncture prevention member 7 in a state where first to third layers are laminated, at least one or more protective materials 9a are present when seen in the laminating direction of the plurality of layers (in this example, three layers). More specifically, as illustrated in FIG. 6B, the puncture prevention member 7 includes a portion comprising one layer of the protective layer (illustrated with sparsest dots), a portion comprising two layers (illustrated with mediumly dense dots) and a portion comprising three layers (a portion having an almost triangular shape in perspective planar view that is illustrated with densest dots).

In this way, the plurality of protective materials 9a are arranged by mutually shifting the phase between the layers so that at least one or more protective materials 9a are present when seen in the laminating direction of the plurality of layers.

Note that there are not any special restrictions on a laminating order of the first to third protective layers, and the order may be any of all possible laminating orders.

In the configuration illustrated in FIG. 6A, FIG. 6B, the internal pressure holding layer 8 can be arbitrarily selected from a natural rubber, a synthetic rubber such as butadiene rubber, styrene butadiene rubber, isoprene rubber, butyl rubber, or nitrile rubber, a thermoplastic elastomer such as styrene-based elastomer, olefin-based elastomer, ester-based elastomer, urethane-based elastomer or polyamide-based elastomer, or any blend of these materials, having a thickness of 0.05 to 1 mm. Furthermore, in the present disclosure, the protective material 9a may be a non-woven fabric, a film, a rubber, a steel plate or any combination of these materials, having a thickness of 0.05 to 3 mm.

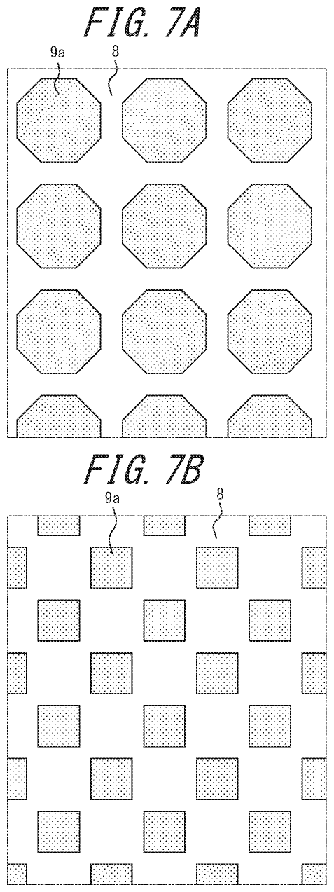

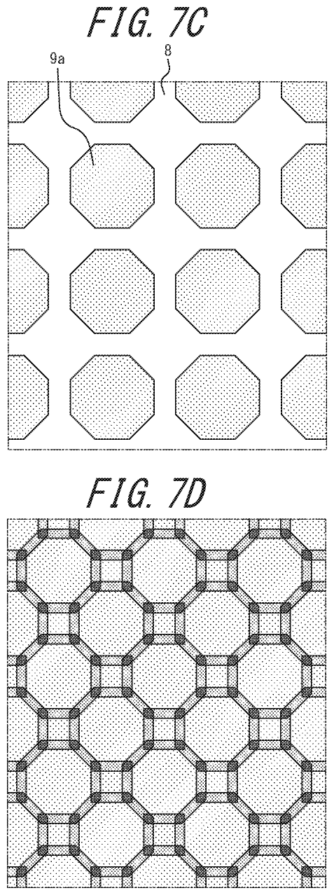

FIG. 7A is a plan view illustrating a first layer of a protective layer of a laminated structure of a puncture prevention member according to a further embodiment. FIG. 7B is a plan view illustrating a second layer of the protective layer of the laminated structure of the puncture prevention member according to the further embodiment. FIG. 7C is a plan view illustrating a third layer of the protective layer of the laminated structure of the puncture prevention member according to the further embodiment. FIG. 7D is a perspective plan view illustrating a configuration where first to third protective layers of the puncture prevention member according to the further embodiment are laminated.

In this example, a puncture prevention member 7 includes one or more (in this example, three) protective layers including an internal pressure holding layer 8, and a protective material 9a disposed on a tire outer surface side of the internal pressure holding layer 8 (in this example, a thin film rubber) in a region of at least a part of an extending region of the internal pressure holding layer 8.

Furthermore, as in the first layer illustrated in FIG. 7A, the puncture prevention member 7 is configured by arranging, in the first layer, a plurality of protective materials 9a having an octagonal shape in planar view. As in the second layer illustrated in FIG. 7B, the puncture prevention member 7 is configured by arranging, in the second layer, a plurality of protective materials 9a having a quadrangular shape in planar view. As in the third layer illustrated in FIG. 7C, the puncture prevention member 7 is configured by arranging, in the first layer, a plurality of protective materials 9a having an octagonal shape in planar view. Furthermore, as illustrated in FIG. 7D, the plurality of protective materials 9a are arranged by mutually shifting a phase between the layers so that at least one or more protective materials 9a are present when seen in a laminating direction of a plurality of layers (in this example, three layers).

As can be understood from FIG. 7D, the protective material 9a having the quadrangular shape in planar view in the second protective layer is disposed just at a center of a column and row of the protective materials 9a having the octagonal shape in the planar view in the first protective layer. Furthermore, the protective materials 9a having the octagonal shape in planar view in the third protective layer are arranged by shifting the materials just by a ½ pitch from the column and row of the protective materials 9a having the octagonal shape in planar view in the first protective layer.

Consequently, as illustrated in FIG. 7D, in the puncture prevention member 7 in a state where the first to third layers are laminated, at least one or more protective materials 9a are present when seen in the laminating direction of the plurality of layers (in this example, three layers). More specifically, as illustrated in FIG. 7D, the puncture prevention member 7 includes a portion comprising one layer of the protective layer (illustrated with sparsest dots), a portion comprising two layers (illustrated with mediumly dense dots) and a portion comprising three layers (illustrated with densest dots).

In this way, the plurality of protective materials 9a are arranged by mutually shifting a phase between the layers so that at least one or more protective materials 9a are present when seen in the laminating direction of the plurality of layers.

Note that there are not any special restrictions on a laminating order of the first to third protective layers, and the order may be any of all possible laminating orders.

In the configuration illustrated in FIG. 7A to FIG. 7D, the internal pressure holding layer 8 can be arbitrarily selected from a natural rubber, a synthetic rubber such as butadiene rubber, styrene butadiene rubber, isoprene rubber, butyl rubber, or nitrile rubber, a thermoplastic elastomer such as styrene-based elastomer, olefin-based elastomer, ester-based elastomer, urethane-based elastomer or polyamide-based elastomer, or any blend of these materials, having a thickness of 0.05 to 1 mm. Furthermore, in the present disclosure, the protective material 9a may be a non-woven fabric, a film, a rubber, a steel plate or any combination of these materials, having a thickness of 0.05 to 3 mm.

Furthermore, in the example illustrated in FIG. 3A to FIG. 3D, the round protective materials 9a are arranged in the column direction and the row direction in each protective layer. However, in the present disclosure, for example, in each protective layer, the protective materials 9 extending continuously in the column direction may be arranged via a space in the row direction. Alternatively, in each protective layer, the protective materials 9 extending continuously in the row direction may be arranged via a space in the column direction, or the materials may be laminated. Also, in this case, a configuration is preferable where at least one or more protective materials 9a are present when seen in the laminating direction of the plurality of layers as described above.

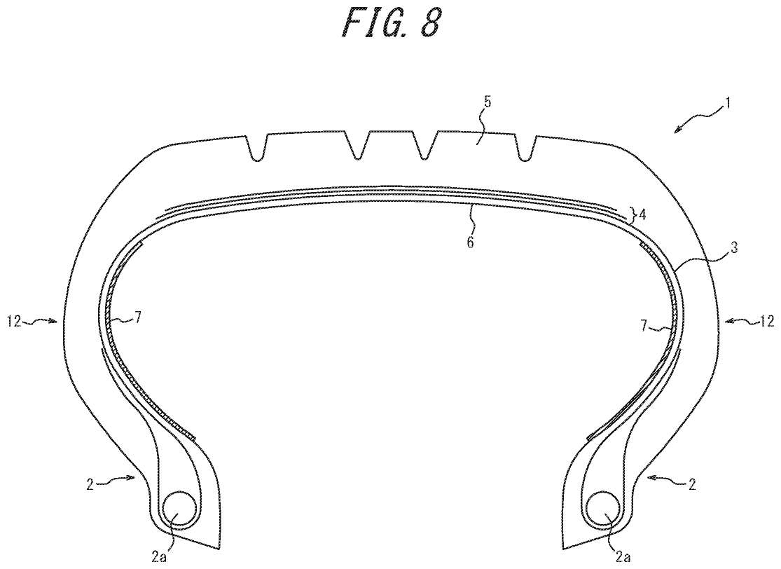

FIG. 8 is a tire width direction cross-sectional view of a pneumatic tire according to a further embodiment of the present disclosure.

FIG. 8 illustrates the tire width direction cross section in a state where a pneumatic tire 1 is mounted to an applicable rim, and charged with a prescribed internal pressure and no load. The tire illustrated in FIG. 8 is different from the tire of the embodiment illustrated in FIG. 1 in a region to which a puncture prevention member 7 is bonded. Specifically, in the tire illustrated in FIG. 8, the puncture prevention member 7 is bonded to an inner surface 6 of a tire body. The puncture prevention member 7 is disposed only in an inner surface of a sidewall portion 12 connected to a pair of bead portions 2 (the inner surface of the sidewall portion 12 that forms a tire radial direction region in a tire inner surface). Furthermore, the puncture prevention member 7 is bonded to a region of at least a part of the inner surface 6 of the tire body, and is specifically bonded only to opposite end portions of the inner surface of the sidewall portion 12 in the inner surface of the sidewall portion 12 (e.g., each region having 3% of a peripheral length of the whole tire inner surface 6), and is not bonded to another region of the inner surface of the sidewall portion 12.

Also according to the tire of the further embodiment illustrated in FIG. 8, the puncture prevention member 7 that satisfies the above relational expressions and is relatively stretchable against rupture strength is disposed in the inner surface of the sidewall portion 12. Consequently, as illustrated in FIG. 2A, FIG. 2B, an input of force by a nail 11 can be sufficiently dispersed, rupture of the puncture prevention member 7 due to the input of force of the nail 11 can be inhibited, and puncture resistance of the tire can be improved. Furthermore, even in case where a cut is generated due to collision of the sidewall portion 12 with an obstacle such as a curbstone when a vehicle is running, the rupture of the puncture prevention member 7 can be inhibited, and the puncture resistance can be improved.

Thus, also according to the tire of this embodiment, the puncture resistance can be improved.

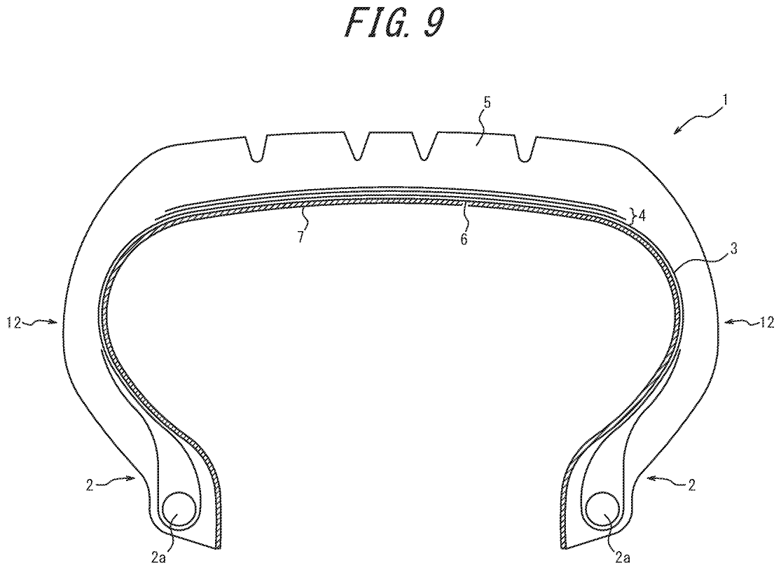

FIG. 9 is a tire width direction cross-sectional view of a pneumatic tire according to a still further embodiment of the present disclosure.

FIG. 9 illustrates the tire width direction cross section in a state where a pneumatic tire 1 is mounted to an applicable rim, and charged with a prescribed internal pressure and no load. The tire illustrated in FIG. 9 is different from the tire of the embodiment illustrated in FIG. 1, FIG. 4 in a region where a puncture prevention member 7 is disposed. Specifically, in the tire illustrated in FIG. 9, the puncture prevention member 7 is disposed entirely in an inner surface 6 of a tire body. Furthermore, the puncture prevention member 7 is bonded to a region of at least a part of the inner surface 6 of the tire body, and is specifically bonded only to a bead portion inner surface, and is not bonded to another region (a tread portion inner surface or an inner surface of a sidewall portion 12).

Also according to the tire of the still further embodiment illustrated in FIG. 9, the puncture prevention member 7 that satisfies the above relational expressions and is relatively stretchable against rupture strength is disposed in the tire inner surface. Consequently, as illustrated in FIG. 2A, FIG. 2B, an input of force by a nail 11 can be sufficiently dispersed, rupture of the puncture prevention member 7 due to the input of force of the nail 11 can be inhibited, and puncture resistance of the tire can be improved. Furthermore, even in case where a cut is generated due to collision with an obstacle such as a curbstone when a vehicle is running, the rupture of the puncture prevention member 7 can be inhibited, and the puncture resistance can be improved.

Thus, also according to the tire of this embodiment, the puncture resistance can be improved.

### EXAMPLES

To check an effect of the present disclosure, tires according to Examples and Comparative Example are made on a trial basis, and a test is performed to evaluate puncture resistance. A tire size of each tire is set to 195/65R15, and an internal pressure of each tire is set to 230 kPa. Table 1 illustrates various factors of each tire together with evaluation results as follows. In Examples, a puncture prevention member is bonded to at least a part of an inner surface of a tire body. Each protective layer is configured to include an internal pressure holding layer, a protective material disposed on a tire outer surface side of the internal pressure holding layer, and a knitted material or a fabric further disposed on the tire outer surface side of the internal pressure holding layer and on a tire inner side of the protective material. In a synthetic rubber thin film used in the internal pressure holding layer, a butyl rubber-based rubber thin film is used, and in a thin film, a thin film made of ethylene-vinyl alcohol copolymer and thermoplastic urethane-based elastomer is used. As the protective material, a film or non-woven fabric made of polyester is used. In Comparative Example, an inner liner made of butyl rubber is disposed on an inner surface of a tire body.

<Puncture Resistance>

A puncture prevention member is disposed on a tire inner surface, and an N100 nail is pushed from an outer surface into the tire inner surface so that a tip of the nail protruded by 20 mm, and air leakage is evaluated after the nail was pulled outside. An air retention rate of 100 immediately after the pull-out is evaluated as good, and an air retention rate of 99 or less is evaluated as bad.

Table 1 illustrates the evaluation result of each test as follows.

TABLE 1

| | | | | | | | | | Comparative |
|---|---|---|---|---|---|---|---|---|---|
| | | | | Example 1 | Example 2 | Example 3 | Example 4 | Example 5 | Example |
| Tire stucture | | | | FIG. 1 | FIG. 1 | FIG. 1 | FIG. 1 | FIG. 1 | F1G. 1 |
| Member | Internal pressure holder layer | | | Synthetic rubber | Film | Synthetic rubber | Synthetic rubber | Synthetic rubber | Inner liner |
| | | | | thin film | | thin film | thin film | thin film | |
| | Protective | Protective | Material | Non-woven | Film | Non-woven | Non-woven | Non-woven | |
| | layer | material | | fabric | | fabric + film | fabric | fabric | |
| | | | Thickness | 2.0 | 0.05 | 0.6 | 2.0 | 1.5 | |
| | | | (mm) | | | | | | |
| | | | Planar | Round | Hexagonal | Hexagonal | Elliptic | Round | |
| | | | shape | | | | | | |

| | | | | | |
|---|---|---|---|---|---|
| Elastic material | — | Nylon | Nylon/ | Nylon/ | Nylon |
| | | knit | polyurethane | polyurethane | knit |
| | | | knit | fabric | |

| | | | | | | |
|---|---|---|---|---|---|---|
| Thickness T (mm) | 0.3 | 0.7 | 1.1 | 0.5 | 1.2 | 1.0 |
| 100% modulus M (Mpa) | 2.0 | 1.1 | 1.0 | 3.3 | 0.5 | 2.0 |
| Initial rigidity Y (N/mm) | 2.2 | 6.6 | 6.3 | 16.9 | 16.7 | 2.6 |
| during nail intruding | | | | | | |
| Penetration strength S (N) | 81 | 190 | 125 | 222 | 120 | 35 |
| Nail intruding amount L(mm) | 80 | 50 | 85 | 35 | 70 | 10 |
| during penetration | | | | | | |
| 100 * M * T + 4.5 | 64.5 | 79.5 | 116.5 | 169.5 | 62.5 | 204.5 |
| Y/(M * T) | 3.7 | 8.8 | 5.6 | 10.2 | 28.5 | 1.3 |
| Puncture resistant performance | Good | Good | Good | Good | Good | Bad |

As illustrated in Table 1, it is seen that a tire according to Example is more superior in puncture resistance to Comparative Example.

### REFERENCE SIGNS LIST

1 pneumatic tire

2 bead portion

2a bead core

3 carcass

4 belt

5 tread

6 inner surface

7 puncture prevention member

7afirst protective layer

7b second protective layer

7c third protective layer

8 internal pressure holding layer

9a protective material

11 nail

12 sidewall portion

TE tread edge

1. A pneumatic tire comprising a puncture prevention member bonded to at least a part of an inner surface of a tire body, wherein the puncture prevention member satisfies relational expressions:
S≥100×M×T+4.5 and Y/(M×T)≥2, where M is a 100% modulus in MPa of a portion of the puncture prevention member in which the 100% modulus is lowest, T is a thickness in mm of the portion of the puncture prevention member, Y is an initial rigidity in N/mm during nail intruding, and S is a penetration strength in N of a portion of the puncture prevention member in which the penetration strength is highest.

2. The pneumatic tire according to claim 1, wherein a gas permeability coefficient of a portion of the puncture prevention member in which the gas permeability coefficient is highest at 60° C. is 6.0×10⁻¹⁰ cc·cm/cm²·sec·cmHg or less.

3. The pneumatic tire according to claim 1, wherein the 100% modulus M of the portion of the puncture prevention member in which the 100% modulus is lowest is from 0.1 to 10 MPa.

4. The pneumatic tire according to claim 3, wherein the 100% modulus M of the portion of the puncture prevention member in which the 100% modulus is lowest is from 0.2 to 7 MPa.

5. The pneumatic tire according to claim 1, wherein in the puncture prevention member, a nail intruding amount L during nail penetration is 20 mm or more.

6. The pneumatic tire according to claim 1, wherein at least a part of the puncture prevention member is away from the inner surface of the tire body during the nail intruding.

7. The pneumatic tire according to claim 2, wherein the 100% modulus M of the portion of the puncture prevention member in which the 100% modulus is lowest is from 0.1 to 10 MPa.

8. The pneumatic tire according to claim 7, wherein the 100% modulus M of the portion of the puncture prevention member in which the 100% modulus is lowest is from 0.2 to 7 MPa.

9. The pneumatic tire according to claim 2, wherein in the puncture prevention member, a nail intruding amount L during nail penetration is 20 mm or more.

10. The pneumatic tire according to claim 3, wherein in the puncture prevention member, a nail intruding amount L during nail penetration is 20 mm or more.

11. The pneumatic tire according to claim 4, wherein in the puncture prevention member, a nail intruding amount L during nail penetration is 20 mm or more.

12. The pneumatic tire according to claim 7, wherein in the puncture prevention member, a nail intruding amount L during nail penetration is 20 mm or more.

13. The pneumatic tire according to claim 2, wherein at least a part of the puncture prevention member is away from the inner surface of the tire body during the nail intruding.

14. The pneumatic tire according to claim 3, wherein at least a part of the puncture prevention member is away from the inner surface of the tire body during the nail intruding.

15. The pneumatic tire according to claim 4, wherein at least a part of the puncture prevention member is away from the inner surface of the tire body during the nail intruding.

16. The pneumatic tire according to claim 7, wherein at least a part of the puncture prevention member is away from the inner surface of the tire body during the nail intruding.

17. The pneumatic tire according to claim 5, wherein at least a part of the puncture prevention member is away from the inner surface of the tire body during the nail intruding.

18. The pneumatic tire according to claim 9, wherein at least a part of the puncture prevention member is away from the inner surface of the tire body during the nail intruding.

19. The pneumatic tire according to claim 8, wherein in the puncture prevention member, a nail intruding amount L during nail penetration is 20 mm or more.

20. The pneumatic tire according to claim 8, wherein at least a part of the puncture prevention member is away from the inner surface of the tire body during the nail intruding.
